(19) United States
(12) Patent Application Publication
(10) Pub. No.: US 2014/0045076 A1
(43) Pub. Date: Feb. 13, 2014

(54) NONAQUEOUS ELECTROLYTE SOLUTION FOR SECONDARY BATTERY AND NONAQUEOUS ELECTROLYTE SECONDARY BATTERY

(71) Applicants: Toshikazu Shishikura, Tokyo (JP); Koji Irie, Tokyo (JP); Shunsuke Saito, Tokyo (JP); Akio Hasatani, Tokyo (JP)

(72) Inventors: Toshikazu Shishikura, Tokyo (JP); Koji Irie, Tokyo (JP); Shunsuke Saito, Tokyo (JP); Akio Hasatani, Tokyo (JP)

(73) Assignee: SHOWA DENKO K.K., Minato-ku, Tokyo (JP)

(21) Appl. No.: 14/113,620

(22) PCT Filed: Apr. 17, 2012
(86) PCT No.: PCT/JP2012/060364

§ 371 Date: Oct. 24, 2013

(30) Foreign Application Priority Data
Apr. 28, 2011 (JP) 2011-101631

(51) Int. Cl. H01M 10/056; H01M 10/0525

(52) U.S. Cl. CPC H01M 10/056; H01M 10/0525
USPC 429/330; 429/188; 429/200; 429/338; 429/342

(57) ABSTRACT

A nonaqueous electrolyte solution for a secondary battery, the nonaqueous electrolyte solution containing an electrolyte, a solvent, and an additive, in which the additive contains a compound represented by formula (1) below, and the content of the compound is 0.01 to 10 parts by mass relative to 100 parts by mass of the total of the solvent. A nonaqueous electrolyte secondary battery employing the nonaqueous electrolyte solution is also disclosed.

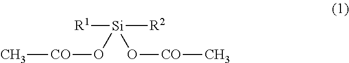

wherein R¹ represents an alkyl group having 1 to 6 carbon atoms, a phenyl group, or an acetoxy group, and R² represents an alkyl group having 1 to 6 carbon atoms, a phenyl group, or a vinyl group.

### TECHNICAL FIELD

The present invention relates to a nonaqueous electrolyte solution for a secondary battery and a nonaqueous electrolyte secondary battery, and more specifically, to a nonaqueous electrolyte secondary battery having good charge-discharge characteristics and a nonaqueous electrolyte solution for a secondary battery, the nonaqueous electrolyte solution being used in the nonaqueous electrolyte secondary battery.

### BACKGROUND ART

Recently, as batteries having high energy densities, nonaqueous electrolyte secondary batteries have attracted attention in which metallic lithium, an alloy that can occlude and release lithium ions, a carbon material, or the like is used as a negative electrode active material and a lithium transition metal oxide represented by a chemical formula LiMO₂ (where M represents a transition metal), lithium iron phosphate having an olivine structure, or the like is used as a positive electrode material.

As an electrolyte solution used as a nonaqueous electrolyte solution, one prepared by dissolving, as an electrolyte, a lithium salt such as LiPF₆, LiBF₄, or LiClO₄ in an aprotic organic solvent is usually used. Examples of the aprotic solvent that are usually used include carbonates such as propylene carbonate, ethylene carbonate, diethyl carbonate, and ethyl methyl carbonate; esters such as γ-butyrolactone and methyl acetate; and ethers such as diethoxyethane.

Furthermore, PTL 1 and PTL 2 describe that a lithium fluorododecaborate represented by Li₂B₁₂F_{X}Z_{12-X} (in the formula, X is an integer of 8 or more and 12 or less, and Z is H, Cl, or Br) is preferably used as an electrolyte from the viewpoint of thermal stability and overcharge characteristics.

However, even in the batteries produced by using LiPF₆ or the lithium fluorododecaborate in the related art, battery characteristics such as cycle characteristics are insufficient. It is believed that this is because an electrolyte solution, in particular, a solvent is decomposed during charging of the battery on the negative electrode side or the positive electrode side or while the battery is left standing with a high voltage, thereby degrading the battery. To solve this problem, as described in NPL 1, it is believed that it is effective to use an additive that forms an ion-conductive protective film suitable for a negative electrode surface or a positive electrode surface.

### CITATION LIST

### Patent Literature

PTL 1: Japanese Unexamined Patent Application Publication No. 2007-87883
PTL 2: Japanese Patent No. 4414306

### Non Patent Literature

NPL 1: GS News Technical Report, June, 2003, Vol. 62, No. 1

### SUMMARY OF INVENTION

### Technical Problem

As described above, various additives, solvents, and electrolytes have been proposed in order to improve the charge-discharge efficiency of a lithium-ion battery. However, they are not sufficient to improve charge-discharge characteristics from low temperatures to high temperatures. In addition, the lithium fluorododecaborate represented by Li₂B₁₂F_{X}Z_{12-X} has good high-temperature characteristics and a significant effect of suppressing the degradation due to overcharging, but does not have a sufficient effect of improving charge-discharge characteristics such as cycle characteristics.

An object of the present invention is to provide a nonaqueous electrolyte solution that can improve charge-discharge characteristics of a nonaqueous electrolyte secondary battery from a low temperature to a high temperature, and a nonaqueous electrolyte secondary battery including the nonaqueous electrolyte solution. An object of the present invention is to provide a nonaqueous electrolyte solution that can further significantly improve high-temperature characteristics and overcharge characteristics of a nonaqueous electrolyte secondary battery, and a nonaqueous electrolyte secondary battery including the nonaqueous electrolyte solution.

### Solution to Problem

The present invention that achieves the above objects is summarized as [1] to [9] below.

[1] A nonaqueous electrolyte solution for a secondary battery, the nonaqueous electrolyte solution containing an electrolyte, a solvent, and an additive,

in which at least one constituting the additive is a compound represented by formula (1) below:

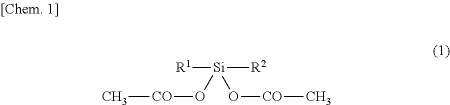

(in the formula (1), R¹ represents an alkyl group having 1 to 6 carbon atoms, a phenyl group, or an acetoxy group, and R² represents an alkyl group having 1 to 6 carbon atoms, a phenyl group, or a vinyl group), and the content of the compound is 0.01 to 10 parts by mass relative to 100 parts by mass of the total of the solvent.
[2] The nonaqueous electrolyte solution for a secondary battery according to [1] above, in which the compound represented by the (1) is at least one selected from the group consisting of methyltriacetoxysilane, ethyltriacetoxysilane, propyltriacetoxysilane, phenyltriacetoxysilane, vinyltriacetoxysilane, and diethyldiacetoxysilane.
[3] The nonaqueous electrolyte solution for a secondary battery according to [1] or [2] above, in which the electrolyte contains a lithium fluorododecaborate represented by a formula Li₂B₁₂F_{X}Z_{12-X} (in the formula, X is an integer of 8 to 12, and Z is H, Cl, or Br) and at least one selected from LiPF₆ and LiBF₄.
[4] The nonaqueous electrolyte solution for a secondary battery according to [3] above, in which the concentration of the lithium fluorododecaborate is 0.2 mol/L or more relative to the total of the electrolyte solution, and the total concentration of the at least one selected from LiPF₆ and LiBF₄ is 0.05 mol/L or more relative to the total of the electrolyte solution.
[5] The nonaqueous electrolyte solution for a secondary battery according to [4] or [5] above, in which a ratio (A:B) of the content A of the lithium fluorododecaborate to the content B of the at least one selected from LiPF₆ and LiBF₄ is 90:10 to 50:50 in terms of molar ratio.
[6] The nonaqueous electrolyte solution for a secondary battery according to any one of [3] to [5] above, in which the total molar concentration of the lithium fluorododecaborate and the at least one selected from LiPF₆ and LiBF₄ is 0.3 to 1.5 mol/L relative to the total of the electrolyte solution.
[7] The nonaqueous electrolyte solution for a secondary battery according to any one of [3] to [6] above, in which X in the formula Li₂B₁₂F_{X}Z_{12-X} is 12.
[8] The nonaqueous electrolyte solution for a secondary battery according to any one of [1] to [7] above, in which the solvent contains at least one selected from the group consisting of cyclic carbonates and chain carbonates, and the compound represented by the formula (1) is contained in an amount of 0.05 to 10 parts by mass relative to 100 parts by mass of the total of the solvent.
[9] A nonaqueous electrolyte secondary battery including a positive electrode, a negative electrode, and the nonaqueous electrolyte solution for a secondary battery according to any one of [1] to [8] above.

### Advantageous Effects of Invention

The nonaqueous electrolyte solution of the present invention contains the additive in a predetermined amount. Thus, charge-discharge characteristics of a nonaqueous electrolyte secondary battery can be significantly improved.

Furthermore, the nonaqueous electrolyte solution of the present invention contains a predetermined amount of lithium fluorododecaborate represented by Li₂B₁₂F_{X}Z_{12-X} (in the formula, X is an integer of 8 or more and 12 or less, and Z is H, Cl, or Br). Thus, charge-discharge characteristics of a nonaqueous electrolyte secondary battery can be significantly improved.

That is, the nonaqueous electrolyte solution of the present invention can improve thermal stability of a nonaqueous electrolyte secondary battery at high temperatures, a charge-discharge performance of the nonaqueous electrolyte secondary battery at low temperatures, and rate characteristics of the nonaqueous electrolyte secondary battery at room temperature. In addition, in the nonaqueous electrolyte solution of the present invention, in the case of overcharging, a redox shuttle mechanism acts, and decomposition of the electrolyte solution and decomposition of a positive electrode can be prevented. As a result, degradation of the nonaqueous electrolyte secondary battery can be prevented.

### BRIEF DESCRIPTION OF DRAWINGS

FIG. 1 is a graph showing cycle test results (a) of a nonaqueous electrolyte secondary battery of Example 1 and cycle test results (b) of a nonaqueous electrolyte secondary battery of Comparative Example 1 at 25° C.

FIG. 2 is a graph showing cycle test results (a) of a nonaqueous electrolyte secondary battery of Example 1 and cycle test results (b) of a nonaqueous electrolyte secondary battery of Comparative Example 1 at 60° C.

FIG. 3 is a graph showing cycle test results (a) of a nonaqueous electrolyte secondary battery of Example 1 and cycle test results (b) of a nonaqueous electrolyte secondary battery of Comparative Example 1 at −10° C.

### DESCRIPTION OF EMBODIMENTS

<Nonaqueous Electrolyte Solution for Secondary Battery>

A nonaqueous electrolyte solution for a secondary battery according to the present invention includes an electrolyte, a solvent, and an additive.

<Additive>

In the present invention, an “additive” is incorporated in an amount of 10 parts by mass or less per additive when the total of the solvent contained in the electrolyte solution of the present invention is assumed to be 100 parts by mass. Furthermore, if a small amount of a solvent component is present in the solvent and the amount of solvent component contained in the small amount is less than 10 parts by mass relative to 100 parts by mass of the total amount of the solvent except for the small amount of the solvent component, the small amount of solvent component is considered to be an additive and is eliminated from the solvent. Herein, in the case where two or more solvent components are present in small amounts and a small amount of certain solvent component (i) is considered to be an additive on the basis of the above definition, a solvent component contained in an amount equal to or smaller than the amount of the solvent component (i) is also considered to be an additive. However, electrolytes described below are excluded.

At least one constituting the additive in the nonaqueous electrolyte solution for a secondary battery of the present invention is a compound represented by formula (1) below.

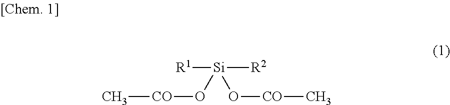

(In the formula (1), R¹ represents an alkyl group having 1 to 6 carbon atoms, a phenyl group, or an acetoxy group, and R² represents an alkyl group having 1 to 6 carbon atoms, a phenyl group, or a vinyl group.)

Since the additive contains the compound represented by the formula (1), in a second battery including the nonaqueous electrolyte solution for a secondary battery of the present invention, a part of this additive is decomposed by reduction on a negative electrode at the time of initial charging, thereby forming a suitable ion-conductive protective coating film on a surface of the negative electrode. As a result, charge-discharge characteristics from a low temperature of about −25° C. to a high temperature of about 60° C. are improved.

In the formula (1), examples of the alkyl group having 1 to 6 carbon atoms and represented by R¹ and R² include a methyl group, an ethyl group, a propyl group, a butyl group, a pentyl group, a hexyl group, an isopropyl group, an isobutyl group, and a t-butyl group.

R¹ is preferably a methyl group, an ethyl group, an acetoxy group, a vinyl group, or the like.

R² is preferably a methyl group, an ethyl group, a phenyl group, a vinyl group, an acetoxy group, an allyl group, an acryloyl group, or the like.

Preferable specific examples of the compound represented by (1) above include methyltriacetoxysilane, ethyltriacetoxysilane, propyltriacetoxysilane, phenyltriacetoxysilane, vinyltriacetoxysilane, and diethyldiacetoxysilane. A nonaqueous electrolyte solution for a secondary battery, the nonaqueous electrolyte solution containing any of these compounds as an additive, can significantly improve charge-discharge characteristics of a second battery from a low temperature to a high temperature of about 60° C.

The additive in the nonaqueous electrolyte solution for a secondary battery of the present invention may be one compound represented by the formula (1) or may include two or more compounds each represented by the formula (1).

The content of the compound represented by the formula (1) in the nonaqueous electrolyte solution for a secondary battery of the present invention is 0.01 to 10 parts by mass, preferably 0.5 to 8 parts by mass, and more preferably 1 to 5 parts by mass relative to 100 parts by mass of the total of the solvent contained in the nonaqueous electrolyte solution for a secondary battery. When the content of the compound represented by the formula (1) is within the above range, a suitable ion-conductive protective coating film can be formed on a surface of the negative electrode. As a result, charge-discharge characteristics from a low temperature to a high temperature can be improved in the second battery. When the content of the compound represented by the formula (1) is lower than 0.01 parts by mass, the protective coating film is not sufficiently formed on the negative electrode, and sufficient charge-discharge characteristics from a low temperature to a high temperature may not be obtained in the second battery. When the content of the compound represented by the formula (1) is higher than 10 parts by mass, the reaction on the negative electrode excessively proceeds, the thickness of the coating film formed on the surface of the negative electrode increases, and the reaction resistance of the negative electrode increases. As a result, a decrease in the discharge capacity of the battery and a decrease in charge-discharge characteristics such as a cycle performance may be caused.

In the case where the solvent contains at least one selected from the group consisting of cyclic carbonates and chain carbonates, the compound represented by the formula (1) above is preferably contained in an amount of 0.05 to 10 parts by mass relative to 100 parts by mass of the total of the solvent from the viewpoint of improving the above effects.

The nonaqueous electrolyte solution for a secondary battery of the present invention may contain, besides the compound represented by the formula (1), other additives according to a desired application within a range that does not impair the effects of the present invention. Examples of the other additives include vinylene carbonate, 4,5-dimethylvinylene carbonate, 4,5-diethylvinylene carbonate, 4,5-dipropylvinylene carbonate, 4-ethyl-5-methylvinylene carbonate, 4-ethyl-5-propylvinylene carbonate, 4-methyl-5-propylvinylene carbonate, vinyl ethylene carbonate, divinyl ethylene carbonate, methyl difluoroacetate, 1,3-propane sultone, 1,4-butane sultone, monofluoroethylene carbonate, and lithium-bisoxalate borate. These other additives may be used alone or in a mixture of two or more additives.

Among these other additives, 1,3-propane sultone is particularly preferable in the case where this additive is added as a mixture with the additive represented by the formula (1). By using 1,3-propane sultone, the charge-discharge characteristics of a secondary battery in a wide temperature range from a low temperature to a high temperature can be easily improved.

In the case where these other additives are used, from the viewpoint of forming a good coating film, the content of each of the other additives is preferably 2 parts by mass or less, and more preferably 1.5 parts by mass or less relative to 100 parts by mass of the total of the solvent described below. In addition, from the viewpoint of forming a good coating film, preferably, the content of the other additives does not exceed the content of the additive represented by the formula (1).

Considering that a coating film having good conductivity is formed, the total amount of additives added is preferably 0.5 to 15 parts by mass, and more preferably 1 to 10 parts by mass relative to 100 parts by mass of the total of the solvent. When the total amount of additives added is smaller than 0.5 parts by mass, a coating film is not sufficiently formed on the negative electrode. As a result, sufficient charge-discharge characteristics may not be obtained. When the total amount of additives added is larger than 15 parts by mass, the thickness of the coating film formed on the surface of the negative electrode increases, and the reaction resistance of the negative electrode increases, which may result in a decrease in charge-discharge characteristics.

<Electrolyte>

The electrolyte is not particularly limited, but preferably includes at least one selected from a lithium fluorododecaborate represented by a formula Li₂B₁₂F_{X}Z_{12-X} (in the formula, X is an integer of 8 to 12, and Z is H, Cl, or Br), LiPF₆ and LiBF₄. It is more preferable to contain both the lithium fluorododecaborate and at least one selected from LiPF₆ and LiBF₄.

By using the lithium fluorododecaborate as an electrolyte, battery characteristics such as high-temperature heat resistance, in particular, the charge-discharge efficiency at 45° C. or higher, 60° C. or higher, and furthermore, 80° C. or higher and the cycle life can be markedly improved as compared with the case where LiPF₆ is used alone. In addition, even in the case of overcharging, not only an increase in the voltage is suppressed and decomposition of a solvent and an electrode is prevented but also the formation of dendrite of lithium can be suppressed by a redox shuttle mechanism due to an anion of the lithium fluorododecaborate. Thus, degradation of the battery and thermal runaway caused by the overcharging can be prevented.

Furthermore, by adding at least one electrolyte salt selected from LiPF₆ and LiBF₄ as a mixed electrolyte, not only the electrical conductivity can be improved but also dissolution of aluminum can be suppressed when aluminum is used as a current collector of a positive electrode.

Whether the lithium fluorododecaborate is used as the electrolyte alone, at least one selected from LiPF₆ and LiBF₄ is used as the electrolyte alone, or both the lithium fluorododecaborate and at least one selected from LiPF₆ and LiBF₄ are used as the electrolyte in the form of a mixture is determined depending on the use of the battery and is not particularly limited. That is, the additive described above can be used in an electrolyte solution containing, as an electrolyte, only at least one selected from LiPF₆ and LiBF₄, an electrolyte solution containing, as an electrolyte, only the lithium fluorododecaborate, and an electrolyte solution containing, as an electrolyte, the lithium fluorododecaborate and at least one selected from LiPF₆ and LiBF₄. However, in the case where the prevention of overcharging is aimed, the nonaqueous electrolyte solution for a secondary battery essentially contains the lithium fluorododecaborate.

Specific examples of the lithium fluorododecaborate include Li₂B₁₂F₈H₄, Li₂B₁₂F₉H₃, Li₂B₁₂F₁₀H₂, Li₂B₁₂F₁₁H, Li₂B₁₂F₁₂, mixtures of lithium fluorododecaborates each represented by the above formula where the average of x is 9 to 10, Li₂B₁₂FₓCl₁₂₋ₓ (in the formula, x is 10 or 11), and Li₂B₁₂FₓBr₁₂₋ₓ (in the formula, x is 10 or 11).

Herein, X in Li₂B₁₂F_{X}Z_{12-X} is an integer of 8 to 12. When X is less than 8, the electric potential that causes a redox reaction is excessively low, and thus the reaction occurs during a so-called usual operation of a lithium-ion battery, which may result in a decrease in the charge-discharge efficiency of the battery. Accordingly, it is necessary to select the numerical value of X in the range of 8 to 12 in accordance with the type of electrode used and the use of the battery. In general, a lithium fluorododecaborate where X in the formula is 12 is easily produced and has a high electric potential that causes a redox reaction. However, the type of lithium fluorododecaborate cannot be generally determined because the characteristics of the lithium fluorododecaborate are affected by the type of electrode and the like. The lithium fluorododecaborate where X in the formula is 12 is preferable from the viewpoint that the electric potential that causes a redox reaction is higher than those of other compounds, the redox reaction does not easily occur in a usual operation of the battery, and thus the redox shuttle mechanism easily effectively acts only in the case of overcharging.

The concentration of the lithium fluorododecaborate is preferably 0.2 mol/L or more, and more preferably 0.3 mol/L or more and 1.0 mol/L or less relative to the total of the electrolyte solution.

When the amount of lithium fluorododecaborate is excessively small, the electrical conductivity is excessively low and the resistance in charging and discharging of the battery is increased, which may result in a degradation of rate characteristics and the like. Furthermore, the action of the redox shuttle mechanism in the case of overcharging may become insufficient. On the other hand, when the amount of lithium fluorododecaborate is excessively large, the viscosity of the electrolyte solution increases and the electrical conductivity decreases, which may result in a decrease in the charge-discharge performance such as rate characteristics.

“At least one selected from LiPF₆ and LiBF₄” may be any of only LiPF, only LiBF₄, and LiPF₆ and LiBF₄. In the case where at least one of LiPF₆ and LiBF₄ is used in combination with the lithium fluorododecaborate, in general, LiPF₆, which has a high electrical conductivity, is preferably used. However, the type of mixed electrolyte selected from LiPF₆ and LiBF₄ cannot be simply determined because there are effects of the affinity of the mixed electrolyte with other additives etc., the specification of the battery, and the like.

The concentration of at least one selected from LiPF₆ and LiBF₄ is preferably 0.05 mol/L or more, and more preferably 0.1 mol/L or more and 0.3 mol/L or less relative to the total of the electrolyte solution.

When the amount of at least one selected from LiPF₆ and LiBF₄ is excessively small, a sufficient protective film is not formed on an aluminum current collector and good charge-discharge characteristics may not be obtained. Furthermore, the electrical conductivity of the electrolyte solution is also insufficient, and good charge-discharge characteristics may not be obtained.

In the case where both the lithium fluorododecaborate and at least one selected from LiPF₆ and LiBF₄ are used as an electrolyte, a ratio (A:B) of the content A of the lithium fluorododecaborate to the content B of the at least one selected from LiPF₆ and LiBF₄ is preferably 90:10 to 50:50, and more preferably 85:15 to 60:40 in terms of molar ratio.

The total molar concentration of the lithium fluorododecaborate and the at least one selected from LiPF₆ and LiBF₄ is preferably 0.3 to 1.5 mol/L, and more preferably 0.4 to 1.3 mol/L relative to the total of the electrolyte solution. When the total molar concentration is within the above range, the electrical conductivity is high and the Li ion concentration also reaches a concentration suitable for a battery reaction.

In the case where both the lithium fluorododecaborate and at least one selected from LiPF₆ and LiBF₄ are used as an electrolyte, the molar concentration of the at least one selected from LiPF₆ and LiEF₄ is preferably equal to or lower than the molar concentration of the lithium fluorododecaborate. When the molar concentration of the at least one selected from LiPF₆ and LiBF₄ is higher than the molar concentration of the lithium fluorododecaborate, heat resistance at a high temperature of 45° C. or higher and charge-discharge characteristics may be decreased, and furthermore, degradation of the battery due to overcharging may not be sufficiently prevented.

<Solvent>

Examples of the solvent include, but are not particularly limited to, cyclic carbonates such as ethylene carbonate, propylene carbonate, and butylene carbonate; chain carbonates such as diethyl carbonate, dimethyl carbonate, methyl ethyl carbonate, methyl propyl carbonate, ethyl propyl carbonate, and dipropyl carbonate; and fluorine-substituted cyclic or chain carbonates, such as trifluoropropylene carbonate, bis(trifluoroethyl)carbonate, and trifluoroethyl methyl carbonate, in which some of hydrogen atoms are substituted with fluorine atoms. These solvents may be used alone or in a mixture of two or more solvents. The solvent preferably contains at least one selected from the group consisting of cyclic carbonates and chain carbonates from the viewpoint that an electrochemically stable range is wide and a good electrical conductivity can be obtained. In order to obtain a good battery performance even over a wide temperature range from a low temperature to a high temperature, a mixed solvent containing two or more solvents is preferably used.

From the viewpoint of improving the battery performance, solvents such as dimethoxyethane, diglyme, triglyme, polyethylene glycol, γ-butyrolactone, sulfolane, methyl acetate, ethyl acetate, propyl acetate, methyl propionate, ethyl propionate, tetrahydrofuran, 2-methyltetrahydrofuran, 1,4-dioxane, and acetonitrile may be used as solvents other than the carbonates mentioned above. However, the solvents are not particularly limited thereto.

<Nonaqueous Electrolyte Secondary Battery>

A nonaqueous electrolyte secondary battery of the present invention includes a positive electrode, a negative electrode, and the above-described nonaqueous electrolyte solution for a secondary battery. Since the nonaqueous electrolyte secondary battery of the present invention includes the nonaqueous electrolyte solution fora secondary battery of the present invention, the nonaqueous electrolyte secondary battery exhibits good charge-discharge characteristics.

The structure and the like of the nonaqueous electrolyte secondary battery are not particularly limited, and may be appropriately selected in accordance with a desired use. The nonaqueous electrolyte secondary battery of the present invention may further include, for example, a separator composed of polyethylene or the like.

The negative electrode used in the present invention is not particularly limited and may contain a current collector, a conductive material, a negative electrode active material, a binder, and/or a thickener.

As the negative electrode active material, any material that can occlude and release lithium can be used without particular limitation. Typical examples thereof include non-graphitized carbon, artificial graphite carbon, natural graphite carbon, metallic lithium, aluminum, lead, silicon, alloys of lithium with tin or the like, tin oxide, and titanium oxide. Any of these negative electrode active materials is kneaded with a binder such as polytetrafluoroethylene (PTFE), polyvinylidene fluoride (PVdF), or styrene-butadiene rubber (SBR) in accordance with a usual method, and the kneaded product can be used as a mixture. The negative electrode can be prepared by using this mixture and a current collector such as a copper foil.

The positive electrode used in the present invention is not particularly limited and preferably contains a current collector, a conductive material, a positive electrode active material, a binder, and/or a thickener.

Typical examples of the positive electrode active material include lithium composite oxides with a transition metal such as cobalt, manganese, or nickel; and lithium composite oxides obtained by replacing a part of the lithium site or the transition metal site of any of the above lithium composite oxides with cobalt, nickel, manganese, aluminum, boron, magnesium, iron, copper, or the like. Furthermore, for example, lithium transition metal phosphates having an olivine structure can also be used. Any of these positive electrode active materials is kneaded with a conductive agent such as acetylene black or carbon black and a binder such as polytetrafluoroethylene (PTFE) or polyvinylidene fluoride (PVdF), and the kneaded product can be used as a mixture. The positive electrode can be prepared by using this mixture and a current collector such as an aluminum foil.

### EXAMPLES

The present invention will now be described in more detail on the basis of Examples. However, the present invention is not limited by the Examples below and can be carried out by making appropriate changes as long as the gist of the present invention is not changed.

(Preparation 1 of Lithium Fluorododecaborate)

[Preparation of Li₂B₁₂F_{X}H_{12-X} (X is 10 to 12)]

First, 100% F₂ (142 mmol) was added as a mixed gas of 10% F₂/10% O₂/80% N₂ at 0° C. to 20° C. to a colorless slurry containing 2.96 g (11.8 mmol) of K₂B₁₂H₁₂CH₃OH in 6 mL of formic acid at an average Hammett acidity of Hₒ=−2 to −4, thus preparing a colorless solution. The above mixed gas was added to this solution at 30° C. to further conduct fluorination (3%). A solid was precipitated from the solution. The solvent was evacuated for one night to prepare 5.1 g of a colorless, brittle solid. This crude product was analyzed by ¹⁹F NMR. According to the results, it was found that the crude product was mainly composed of B₁₂F₁₀H₂²⁻ (60%), B₁₂F₁₁H²⁻ (35%), and B₁₂F₁₂²⁻ (5%). The crude reaction product was dissolved in water, and the pH of the solution was adjusted to 4 to 6 with triethylamine and trimethylamine hydrochloride. The precipitated product was filtered and dried. The dried product was again suspended in water to prepare a slurry. Two equivalents of lithium hydroxide monohydrate were added to this slurry, and triethylamine was removed. After the triethylamine was completely removed by distillation, lithium hydroxide was further added thereto, and the pH of the final solution was adjusted to 9.5. Water was removed by distillation, and the final product was dried under vacuum at 200° C. for six hours. The yield of Li₂B₁₂FₓH₁₂₋ₓ (x=10, 11, or 12) was about 75%.

(Preparation 2 of Lithium Fluorododecaborate)

[Preparation of Li₂B₁₂FₓBr₁₂₋ₓ (x≧10, average x=11)]

Three grams (0.008 mol) of Li₂B₁₂FₓH₁₂₋ₓ (x≧10) having an average composition of Li₂B₁₂F₁₁H was dissolved in 160 mL of 1 M HCl. Next, 1.4 mL (0.027 mol) of Br₂ was added to this solution, and the resulting liquid mixture was refluxed at 100° C. for four hours. A sample was taken for the purpose of NMR analysis.

A part of the sample was returned to the reflux, and chlorine was added thereto over a period of six hours to form a brominating agent BrCl. At the time when the addition of chlorine was completed, a sample was taken and analyzed by NMR. The result showed that the sample had the same composition as the composition before the addition of chlorine. Water and HCl were removed by distillation, and the resulting product was dried under vacuum at 150° C. A total 2.55 g of a white solid product was isolated. The theoretical amount of the obtained Li₂B₁₂FₓBr₁₂₋ₓ (x≧10, average x=11) is 3.66 g.

(Preparation 3 of Lithium Fluorododecaborate)

[Preparation of Li₂B₁₂FₓCl₁₂₋ₓ (Average x=11)]

Twenty grams of a mixture of Li₂B₁₂F_{X}H_{12-X} having an average composition of Li₂B₁₂F₁₁H was dissolved in 160 mL of 1M HCl in a three-necked round-bottom flask equipped with a reflux condenser and a glass bubbler (fritted bubbler). The resulting liquid mixture was heated to 100° C. and bubbled with Cl₂ gas at 15 standard cubic centimeters per minute (sccm/min). A discharged solution passing through the condenser was allowed to pass through a solution containing KOH and Na₂SO₃. Bubbling was performed with Cl₂ for 16 hours and the solution was then purged with air. Water and HCl were removed by distillation, and the residue was titrated with an ether. The ether was evaporated, and a white solid was dried in a vacuum dryer. Thus, 20 g of a substance represented by Li₂B₁₂FₓCl₁₂₋ₓ (average x=11) was recovered (yield 92%). ¹⁹F-NMR in D₂O: −260.5, 0.035F; −262.0, 0.082F; −263.0, 0.022F; −264.5, 0.344F; −265.5, 0.066F; −267.0, 0.308F; −268.0, 0.022F; −269.5, 1.0F. ¹¹B-NMR in D₂O: −16.841; −17.878.

### Example 1

[Preparation of Electrolyte Solution]

Lithium hexafluorophosphate (LiPF₆) was used as an electrolyte. A solvent composed of a mixture containing 20% by volume of ethylene carbonate, 20% by volume of propylene carbonate, 40% by volume of methyl ethyl carbonate, and 20% by volume of diethyl carbonate was used. Lithium hexafluorophosphate (LiPF₆) was dissolved in this solvent so as to have a concentration of 1.2 mol/L. Furthermore, as an additive for forming an ion-conductive coating film on an electrode, 2.0 parts by mass of ethyltriacetoxysilane was added relative to 100 parts by mass of the total of the solvent. Thus, an electrolyte solution was prepared.

[Preparation of Positive Electrode]

First, LiCo_{1/3}Ni_{1/3}Mn_{1/3}O₂ functioning as a positive electrode active material, a carbon material functioning as a conductive agent, and an N-methyl-2-pyrrolidone solution in which polyvinylidene fluoride functioning as a binder was dissolved were mixed so that a mass ratio of the active material, the conductive agent, and the binder was 95:2.5:2.5. The mixture was then kneaded to prepare a positive electrode slurry. The prepared slurry was applied onto an aluminum foil functioning as a current collector, and then dried. The resulting aluminum foil was then rolled with a rolling mill, and a current collector tab was attached thereto. Thus, a positive electrode was prepared.

[Preparation of Negative Electrode]

Artificial graphite functioning as a negative electrode active material, an SBR functioning as a binder, and carboxymethyl cellulose functioning as a thickener were mixed with water so that a mass ratio of the active material, the binder, and the thickener was 97.5:1.5:1. The mixture was then kneaded to prepare a negative electrode slurry. The prepared slurry was applied onto a copper foil functioning as a current collector, and then dried. The resulting copper foil was then rolled with a rolling mill, and a current collector tab was attached thereto. Thus, a negative electrode was prepared.

[Preparation of Battery]

The positive electrode and negative electrode prepared as described above were made to face each other with a polyethylene separator therebetween, and put in an aluminum laminated container. In a glove box in an Ar (argon) atmosphere, the electrolyte solution prepared as described above was added dropwise to the container including the electrodes therein, and the laminated container was thermo-compression bonded while the pressure was removed. Thus, a battery was prepared.

[Evaluation of Battery]

The battery prepared as described above was slowly charged up to 4.2 V at 0.05 C (a current at which full charging or full discharging is performed in 1/0.05 hours (=20 hours)) and then slowly discharged down to 3.0 V, and the charging and discharging operation was then performed once more. Thus, aging was performed.

Subsequently, constant-current charging was conducted up to 4.2 V at 25° C. at 1 C. When the voltage reached 4.2 V, the battery was maintained at this voltage until the current was decreased to a value corresponding to 0.05 C. Subsequently, discharging was conducted at a constant current of 1 C until the battery voltage became 3.0 V. The discharge capacity at this time was defined as a (an initial) discharge capacity at the first cycle (initial discharge capacity). Furthermore, the charging and discharging operation was repeatedly performed by the same method to examine the cycle performance of the battery. FIG. 1 shows the results of this cycle test. In the battery of Example 1, the discharge capacity for each cycle is shown by curve a in FIG. 1. Even after 500 cycles, the decrease in the capacity was small and 92% of the initial discharge capacity was maintained.

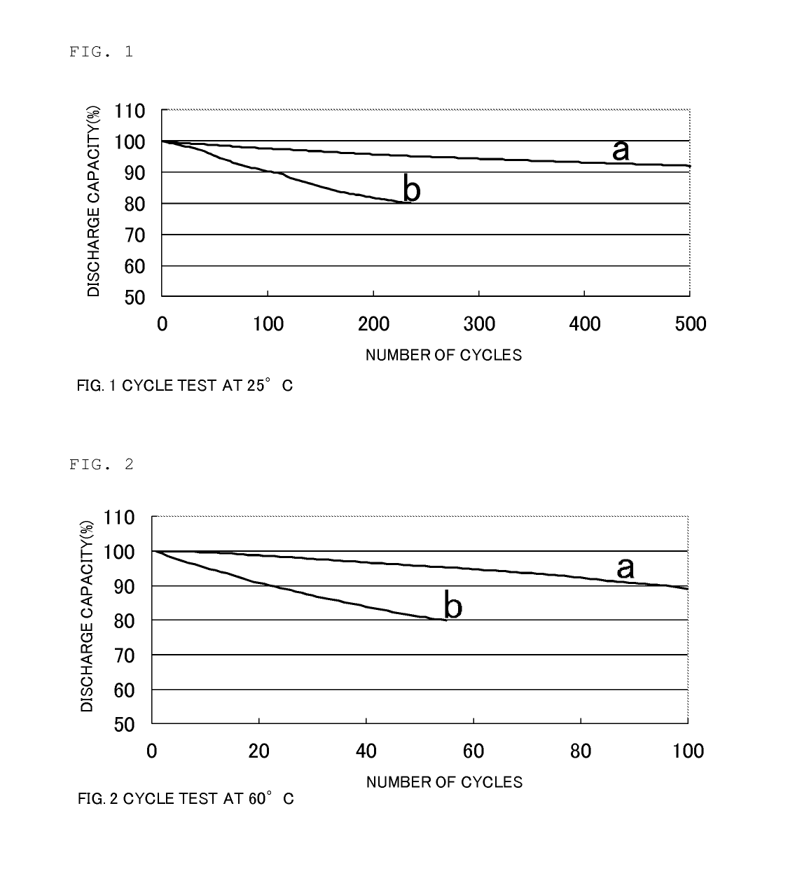

A battery was prepared in the same manner, and the cycle performance of this battery was examined at 60° C. as in the above test. FIG. 2 shows the results of this cycle test. In the battery of Example 1, the discharge capacity for each cycle is shown by curve a in FIG. 2. Even after 100 cycles, 89% of the initial discharge capacity was maintained.

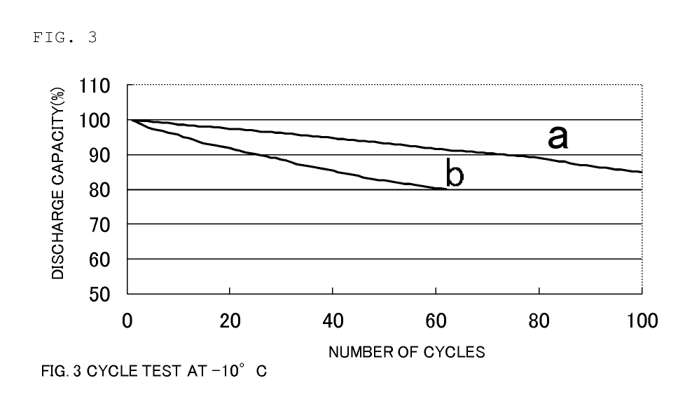

A battery was prepared in the same manner, and the cycle performance of this battery was examined at −10° C. as in the above test. FIG. 3 shows the results of this cycle test. In the battery of Example 1, the discharge capacity for each cycle is shown by curve a in FIG. 3. Even after 100 cycles, 85% of the initial discharge capacity was maintained.

### Example 2

[Preparation of Electrolyte Solution]

Lithium hexafluorophosphate (LiPF₆) was used as an electrolyte. A solvent composed of a mixture containing 30% by volume of ethylene carbonate, 30% by volume of methyl ethyl carbonate, and 40% by volume of diethyl carbonate was used. Lithium hexafluorophosphate (LiPF₆) was dissolved in this solvent so as to have a concentration of 1.2 mol/L. Furthermore, as an additive for forming an ion-conductive coating film on an electrode, 2.0 parts by mass of vinyltriacetoxysilane was added relative to 100 parts by mass of the total of the solvent. Thus, an electrolyte solution was prepared.

[Preparation of Positive Electrode]

First, LiCo_{1/3}Ni_{1/3}Mn_{1/3}O₂ functioning as a positive electrode active material, a carbon material functioning as a conductive agent, and an N-methyl-2-pyrrolidone solution in which polyvinylidene fluoride functioning as a binder was dissolved were mixed so that a mass ratio of the active material, the conductive agent, and the binder was 95:2.5:2.5. The mixture was then kneaded to prepare a positive electrode slurry. The prepared slurry was applied onto an aluminum foil functioning as a current collector, and then dried. The resulting aluminum foil was then rolled with a rolling mill, and a current collector tab was attached thereto. Thus, a positive electrode was prepared.

[Preparation of Negative Electrode]

Natural graphite functioning as a negative electrode active material, an SBR functioning as a binder, and carboxymethyl cellulose functioning as a thickener were mixed with water so that a mass ratio of the active material, the binder, and the thickener was 97.5:1.5:1. The mixture was then kneaded to prepare a negative electrode slurry. The prepared slurry was applied onto a copper foil functioning as a current collector, and then dried. The resulting copper foil was then rolled with a rolling mill, and a current collector tab was attached thereto. Thus, a negative electrode was prepared.

[Preparation of Battery]

The positive electrode and negative electrode prepared as described above were made to face each other with a polyethylene separator therebetween, and put in an aluminum laminated container. In a glove box in an Ar (argon) atmosphere, the electrolyte solution prepared as described above was added dropwise to the container including the electrodes therein, and the laminated container was thermo-compression bonded while the pressure was removed. Thus, a battery was prepared.

[Evaluation of Battery]

This battery was aged as in Example 1.

Subsequently, constant-current charging was conducted up to 4.2 V at 25° C. at 1 C. When the voltage reached 4.2 V, the battery was maintained at this voltage until the current was decreased to 0.05 C. Subsequently, discharging was conducted at a constant current of 1 C until the battery voltage became 3.0 V. The discharge capacity at this time was defined as a (an initial) discharge capacity at the first cycle (initial discharge capacity). Furthermore, the charging and discharging operation was repeatedly performed by the same method to examine the cycle performance of the battery. In the battery of Example 2, the discharge capacity after 500 cycles maintained 93% of the initial discharge capacity.

In addition, a battery was prepared in the same manner, and the cycle performance of this battery was examined at 60° C. as in the above test. In the battery of Example 2, the discharge capacity after 100 cycles maintained 91% of the initial discharge capacity.

A battery was prepared in the same manner, and the cycle performance of this battery was examined at −10° C. as in the above test. In the battery of Example 2, the discharge capacity at the 100th cycle maintained 88% of the initial discharge capacity.

### Example 3

[Preparation of Electrolyte Solution]

A lithium fluorododecaborate that was separated from the product obtained in Preparation 1 of lithium fluorododecaborate so as to contain 99.9% or more of a lithium fluorododecaborate having a composition formula of Li₂B₁₂F₁₂ was used as an electrolyte, and LiPF₆ was used as a mixed electrolyte. A solvent composed of a mixture containing 10% by volume of ethylene carbonate, 20% by volume of propylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as an additive for forming an ion-conductive coating film on an electrode, 1.5 parts by mass of methyltriacetoxysilane was added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 94% of the initial discharge capacity. In the cycle test at 60° C., the discharge capacity at the 100th cycle maintained 90% of the initial discharge capacity. In the cycle test at −0° C., 88% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.73 V and did not increase any more. This battery was discharged at 25° C. at a discharge rate of 1 C. According to the result, discharging at 94% of the initial discharge capacity could be achieved (Test A). Subsequently, constant-current constant-voltage (CCCV) charging was conducted at a rate of 1 C up to 4.2 V, and discharging was conducted at 1 C down to 3.0 V. This charging and discharging operation was repeatedly performed. At the 500th cycle, 88% of the initial discharge capacity was maintained (Test B). Accordingly, it was found that the battery did not degrade due to overcharging.

### Example 4

[Preparation of Electrolyte Solution]

Lithium hexafluorophosphate (LiPF₆) was used as an electrolyte. A solvent composed of a mixture containing 10% by volume of ethylene carbonate, 20% by volume of propylene carbonate, 50% by volume of methyl ethyl carbonate, and 20% by volume of diethyl carbonate was used. Lithium hexafluorophosphate (LiPF₆) was dissolved in this solvent so as to have a concentration of 1.2 mol/L. Furthermore, as an additive for forming an ion-conductive coating film on an electrode, 2.0 parts by mass of phenyltriacetoxysilane was added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 90% of the initial discharge capacity. In the cycle test at 60° C., the discharge capacity at the 100th cycle maintained 82% of the initial discharge capacity. In the cycle test at −10° C., 83% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. After the state of charging exceeded 150%, the battery voltage became 5.2 V or more. Subsequently, with an increase in the state of charging, the voltage gradually increased. From the time when the state of charging exceeded about 180%, the voltage rapidly increased. The battery voltage reached 10.0 V at a state of charging of 195%, and the overcharge test was finished. This battery was then discharged at 25° C. at a discharge rate of 1 C. According to the result, discharging at only 2% of the initial discharge capacity was achieved (Test A). Subsequently, CCCV charging, in which charging was conducted at 1 C until the battery voltage reached 4.2 V and the voltage was maintained from the time when the battery voltage reached 4.2 V until a current value became 0.05 C, and discharging at 1 C down to 3.0 V were repeatedly performed. Even after these charging and discharging were conducted for 10 cycles, the discharge capacity did not exceed 10% of the initial discharge capacity, and the test was finished (Test B).

### Example 5

[Preparation of Electrolyte Solution]

A lithium fluorododecaborate that was separated from the product obtained in Preparation 2 of lithium fluorododecaborate so as to contain 99.9% or more of a lithium fluorododecaborate having a composition formula of Li₂B₁₂F₁₁Br was used as an electrolyte, and LiPF₆ was used as a mixed electrolyte. A solvent composed of a mixture containing 10% by volume of ethylene carbonate, 20% by volume of propylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as an additive for forming an ion-conductive coating film on an electrode, 2.0 parts by mass of vinyltriacetoxysilane was added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 86% of the initial discharge capacity. In the cycle test at 60° C., the discharge capacity at the 100th cycle maintained 80% of the initial discharge capacity. In the cycle test at −10° C., 76% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.71V and did not increase any more. This battery was discharged at 25° C. at a discharge rate of 1 C. According to the result, discharging at 87% of the initial discharge capacity could be achieved (Test A). Subsequently, CCCV charging was conducted at a rate of 1 C up to 4.2 V, and discharging was conducted at 1 C down to 3.0 V. This charging and discharging operation was repeatedly performed. At the 100th cycle, 76% of the initial discharge capacity was maintained (Test B).

Accordingly, it was found that the battery did not substantially degrade due to overcharging.

### Example 6

[Preparation of Electrolyte Solution]

A lithium fluorododecaborate that was separated from the product obtained in Preparation 3 of lithium fluorododecaborate so as to contain 99.9% or more of a lithium fluorododecaborate having a composition formula of Li₂B₁₂F₁₁Cl was used as an electrolyte, and LiPF₆ was used as a mixed electrolyte. A solvent composed of a mixture containing 10% by volume of ethylene carbonate, 20% by volume of propylene carbonate, 50% by volume of methyl ethyl carbonate, and 20% by volume of diethyl carbonate was used.

The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as additives for forming an ion-conductive coating film on an electrode, 1.0 part by mass of vinyltriacetoxysilane and 0.75 parts by mass of 1,3-propane sultone were added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 84% of the initial discharge capacity. In the cycle test at 60° C., the discharge capacity at the 100th cycle maintained 80% of the initial discharge capacity. In the cycle test at −10° C., 78% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.72 V and did not increase any more. This battery was discharged at 25° C. at a discharge rate of 1 C. According to the result, discharging at 88% of the initial discharge capacity could be achieved (Test A). Subsequently, CCCV charging was conducted at a rate of 1 C up to 4.2 V, and discharging was conducted at 1 C down to 3.0 V. This charging and discharging operation was repeatedly performed. At the 100th cycle, 82% of the initial discharge capacity was maintained (Test B). Accordingly, it was found that the battery did not substantially degrade due to overcharging.

### Example 7

[Preparation of Electrolyte Solution]

Lithium hexafluorophosphate (LiPF₆) was used as an electrolyte. A solvent composed of a mixture containing 10% by volume of ethylene carbonate, 20% by volume of propylene carbonate, 50% by volume of methyl ethyl carbonate, and 20% by volume of diethyl carbonate was used. Lithium hexafluorophosphate (LiPF₆) was dissolved in this solvent so as to have a concentration of 1.2 mol/L. Furthermore, as additives for forming an ion-conductive coating film on an electrode, 1.5 parts by mass of diethyldiacetoxysilane and 0.75 parts by mass of 1,3-propane sultone were added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 95% of the initial discharge capacity. In the cycle test at 60° C., the discharge capacity at the 100th cycle maintained 90% of the initial discharge capacity. In the cycle test at −10° C., 86% of the initial discharge capacity was maintained at the 100th cycle.

### Example 8

[Preparation of Electrolyte Solution]

A lithium fluorododecaborate that was separated from the product obtained in Preparation 1 of lithium fluorododecaborate so as to contain 99.9% or more of a lithium fluorododecaborate having a composition formula of Li₂B₁₂F₁₂ was used as an electrolyte, and LiPF₆ was used as a mixed electrolyte. A solvent composed of a mixture containing 30% by volume of ethylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as an additive for forming an ion-conductive coating film on an electrode, 1.0 part by mass of propyltriacetoxysilane was added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 86% of the initial discharge capacity. In the cycle test at 60° C., the discharge capacity at the 100th cycle maintained 77% of the initial discharge capacity. In the cycle test at −10° C., 81% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.78 V and did not increase any more. This battery was discharged at 25° C. at a discharge rate of 1 C. According to the result, discharging at 85% of the initial discharge capacity could be achieved (Test A).

### Example 9

[Preparation of Electrolyte Solution]

A lithium fluorododecaborate that was separated from the product obtained in Preparation 1 of lithium fluorododecaborate so as to contain 99.9% or more of a lithium fluorododecaborate having a composition formula of Li₂B₁₂F₁₂ was used as an electrolyte, and LiPF₆ was used as a mixed electrolyte. A solvent composed of a mixture containing 30% by volume of ethylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as additives for forming an ion-conductive coating film on an electrode, 1.5 parts by mass of vinyltriacetoxysilane and 0.5 parts by mass of 1,3-propane sultone were added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 94% of the initial discharge capacity. In the cycle test at 60° C., the discharge capacity at the 100th cycle maintained 92% of the initial discharge capacity. In the cycle test at −10° C., 88% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.70 V and did not increase any more. This battery was discharged at 25° C. at a discharge rate of 1 C. According to the result, discharging at 98% of the initial discharge capacity could be achieved (Test A).

### Example 10

[Preparation of Electrolyte Solution]

A lithium fluorododecaborate that was separated from the product obtained in Preparation 1 of lithium fluorododecaborate so as to contain 99.9% or more of a lithium fluorododecaborate having a composition formula of Li₂B₁₂F₁₂ was used as an electrolyte, and LiPF₆ was used as a mixed electrolyte. A solvent composed of a mixture containing 30% by volume of ethylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Furthermore, as additives for forming an ion-conductive coating film on an electrode, 1.5 parts by mass of ethyltriacetoxysilane and 0.8 parts by mass of lithium-bisoxalate borate were added relative to 100 parts by mass of the total of the solvent. Thus, an electrolyte solution was prepared.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity at the 500th cycle maintained 91% of the initial discharge capacity. In the cycle test at 60° C., the discharge capacity at the 100th cycle maintained 88% of the initial discharge capacity. In the cycle test at −10° C., 87% of the initial discharge capacity was maintained at the 100th cycle.

In addition, a battery was prepared in the same manner as described above, and charging and discharging of this battery were conducted at 25° C. for five cycles. An overcharge test was then conducted at 25° C. at a rate of 3 C. Even when the state of charging was increased to 300%, the battery voltage became substantially constant at 4.71 V and did not increase any more. This battery was discharged at 25° C. at a discharge rate of 1 C. According to the result, discharging at 90% of the initial discharge capacity could be achieved (Test A).

### Comparative Example 1

[Preparation of Electrolyte Solution]

Lithium hexafluorophosphate (LiPF₆) was used as an electrolyte. A solvent composed of a mixture containing 10% by volume of ethylene carbonate, 20% by volume of propylene carbonate, 50% by volume of methyl ethyl carbonate, and 20% by volume of diethyl carbonate was used. Lithium hexafluorophosphate (LiPF₆) was dissolved in this solvent so as to have a concentration of 1.2 mol/L. Thus, an electrolyte solution was prepared. No additive for forming a coating film was added to this electrolyte solution.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. FIG. 1 shows the results of the cycle test at 25° C. In the cycle test at 25° C., the discharge capacity of the battery of Comparative Example 1 decreased to less than 80% of the initial discharge capacity at the 235th cycle, as shown by curve b in FIG. 1. FIG. 2 shows the results of the cycle test at 60° C. In the cycle test at 60° C., the discharge capacity decreased to less than 80% of the initial discharge capacity at the 55th cycle, as shown by curve b in FIG. 2. FIG. 1 shows the results of the cycle test at −10° C. In the cycle test at −10° C., the discharge capacity decreased to less than 80% of the initial discharge capacity at the 62nd cycle, as shown by curve b in FIG. 3.

### Comparative Example 2

[Preparation of Electrolyte Solution]

A lithium fluorododecaborate that was separated from the product obtained in Preparation 1 of lithium fluorododecaborate so as to contain 99.9% or more of a lithium fluorododecaborate having a composition formula of Li₂B₁₂F₁₂ was used as an electrolyte, and LiPF₆ was used as a mixed electrolyte. A solvent composed of a mixture containing 10% by volume of ethylene carbonate, 20% by volume of propylene carbonate, 50% by volume of methyl ethyl carbonate, and 20% by volume of diethyl carbonate was used. The lithium fluorododecaborate and LiPF₆ were dissolved in this solvent so that the concentration of the lithium fluorododecaborate was 0.4 mol/L and the concentration of LiPF₆ was 0.2 mol/L. Thus, an electrolyte solution was prepared. No additive for forming an ion-conductive coating film on an electrode was added to this electrolyte solution.

[Preparation of Battery]

A battery was fabricated as in Example 1 using a positive electrode and a negative electrode that were the same as those used in Example 1 except for the electrolyte solution.

[Evaluation of Battery]

The battery evaluation was also conducted as in Example 1. According to the results, in the cycle test at 25° C., the discharge capacity decreased to less than 80% of the initial discharge capacity at the 240th cycle. In the cycle test at 60° C., the discharge capacity decreased to less than 80% of the initial discharge capacity at the 98th cycle. In the cycle test at −10° C., the discharge capacity decreased to less than 80% of the initial discharge capacity at the 89th cycle.

The results of the Examples and Comparative Examples described above are summarized in Table 1.

The following characters shown in Table 1 represent the substances below.

EC: ethylene carbonate

PC: propylene carbonate

MEC: methyl ethyl carbonate

DEC: diethyl carbonate

PS: 1,3-propane sultone

LiBOB: lithium-bisoxalate borate

CNM: LiCo_{1/3}Ni_{1/3}Nn_{1/3}O₂

In Table 1, the term “discharge capacity ratio” means a ratio of the discharge capacity after a test to the initial discharge capacity.

TABLE 1

| | | | | | | | | Overcharge test |
|---|---|---|---|---|---|---|---|---|
| | | | | | Cycle test | | | Discharge |
| | Positive | Negative | Electrolyte solution (mol/L) | Additive | Discharge capacity ratio (%) | | | capacity |
| | electrode | electrode | Solvent (volume %) | (parts by mass) | 25° C. | 60° C. | −10° C. | ratio (%) |
| Example 1 | CNM | Artificial | LiPF₆ (1.2) | Ethyltriacetoxysilane | 92 | 89 | 85 | |
| | | graphite | EC (20), PC (20), MEC (40), DEC (20) | (2.0) | | | | |
| Example 2 | CNM | Natural | LiPF₆ (1.2) | Vinyltriacetoxysilane | 93 | 91 | 88 | |
| | | graphite | EC (30), MEC (30), DEC (40) | (2.0) | | | | |
| Example 3 | CNM | Artificial | Li₂B₁₂F₁₂ (0.4), LiPF₆ (0.2) | Methyltriacetoxysilane | 94 | 90 | 88 | (Test A) 94 |
| | | graphite | EC (10), PC (20), MEC (50), DEC (20) | (1.5) | | | | (Test B) 88 |
| Example 4 | CNM | Artificial | LiPF₆ (1.2) | Phenyltriacetoxysilane | 90 | 82 | 83 | — |
| | | graphite | EC (10), PC (20), MEC (50), DEC (20) | (2.0) | | | | |
| Example 5 | CNM | Artificial | Li₂B₁₂F₁₁Br (0.4), LiPF₆ (0.2) | Vinyltriacetoxysilane | 86 | 80 | 76 | (Test A) 87 |
| | | graphite | EC (10), PC (20), MEC (50), DEC (20) | (2.0) | | | | (Test B) 76 |
| Example 6 | CNM | Artificial | Li₂B₁₂F₁₁Cl (0.4), LiPF₆ (0.2) | Vinyltriacetoxysilane | 84 | 80 | 78 | (Test A) 88 |
| | | graphite | EC (10), PC (20), MEC (50), DEC (20) | (1.0) + PS (0.75) | | | | (Test B) 82 |
| Example 7 | CNM | Artificial | LiPF₆ (1.2) | Diethyldiacetoxysilane | 95 | 90 | 86 | |
| | | graphite | EC (10), PC (20), MEC (50), DEC (20) | (1.5) + PS (0.75) | | | | |
| Example 8 | CNM | Artificial | Li₂B₁₂F₁₂ (0.4), LiPF₆ (0.2) | Propyltriacetoxysilane | 86 | 77 | 81 | (Test A) 85 |
| | | graphite | EC (30), MEC (50), DEC (20) | (1.0) | | | | |
| Example 9 | CNM | Artificial | Li₂B₁₂F₁₂ (0.4), LiPF₆ (0.2) | Vinyltriacetoxysilane | 94 | 92 | 88 | (Test A) 98 |
| | | graphite | EC (30), MEC (50), DEC (20) | (1.5) + PS (0.5) | | | | |
| Example 10 | CNM | Artificial | Li₂B₁₂F₁₂ (0.4), LiPF₆ (0.2) | Ethyltriacetoxysilane | 91 | 88 | 87 | (Test A) 90 |
| | | graphite | EC (30), MEC (50), DEC (20) | (1.5) + LiBOB (0.8) | | | | |
| Comparative | CNM | Artificial | LiPF₆ (1.2) | Not added | — | — | — | |
| Example 1 | | graphite | EC (10), PC (20), MEC (50), DEC (20) | | | | | |
| Comparative | CNM | Artificial | Li₂B₁₂F₁₂ (0.4), LiPF₆ (0.2) | Not added | — | — | — | |
| Example 2 | | graphite | EC (10), PC (20), MEC (50), DEC (20) | | | | | |

1. A nonaqueous electrolyte solution for a secondary battery, the nonaqueous electrolyte solution comprising an electrolyte; a solvent; and an additive,
wherein at least one constituting the additive is a compound represented by formula (1) below: 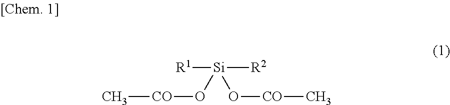
(in the formula (1), R¹ represents an alkyl group having 1 to 6 carbon atoms, a phenyl group, or an acetoxy group, and R² represents an alkyl group having 1 to 6 carbon atoms, a phenyl group, or a vinyl group), and
the content of the compound is 0.01 to 10 parts by mass relative to 100 parts by mass of the total of the solvent.

2. The nonaqueous electrolyte solution for a secondary battery according to claim 1, wherein the compound represented by the (1) is at least one selected from the group consisting of methyltriacetoxysilane, ethyltriacetoxysilane, propyltriacetoxysilane, phenyltriacetoxysilane, vinyltriacetoxysilane, and diethyldiacetoxysilane.

3. The nonaqueous electrolyte solution for a secondary battery according to claim 1, wherein the electrolyte contains a lithium fluorododecaborate represented by a formula Li₂B₁₂F_{X}Z_{12-X} (in the formula, X is an integer of 8 to 12, and Z is H, Cl, or Br) and at least one selected from LiPF₆ and LiBF₄.

4. The nonaqueous electrolyte solution for a secondary battery according to claim 3, wherein the concentration of the lithium fluorododecaborate is 0.2 mol/L or more relative to the total of the electrolyte solution, and the total concentration of the at least one selected from LiPF₆ and LiBF₄ is 0.05 mol/L or more relative to the total of the electrolyte solution.

5. The nonaqueous electrolyte solution for a secondary battery according to claim 3, wherein a ratio (A:B) of the content A of the lithium fluorododecaborate to the content B of the at least one selected from LiPF₆ and LiBF₄ is 90:10 to 50:50 in terms of molar ratio.

6. The nonaqueous electrolyte solution for a secondary battery according to claim 3, wherein the total molar concentration of the lithium fluorododecaborate and the at least one selected from LiPF₆ and LiBF₄ is 0.3 to 1.5 mol/L relative to the total of the electrolyte solution.

7. The nonaqueous electrolyte solution for a secondary battery according to claim 3, wherein X in the formula Li₂B₁₂F_{X}Z_{12-X} is 12.

8. The nonaqueous electrolyte solution for a secondary battery according to claim 1, wherein the solvent contains at least one selected from the group consisting of cyclic carbonates and chain carbonates, and the compound represented by the formula (1) is contained in an amount of 0.05 to 10 parts by mass relative to 100 parts by mass of the total of the solvent.

9. A nonaqueous electrolyte secondary battery comprising a positive electrode; a negative electrode; and the nonaqueous electrolyte solution for a secondary battery according to claim 1.
